(19) United States
(12) Patent Application Publication
(10) Pub. No.: US 2010/0208282 A1
(43) Pub. Date: Aug. 19, 2010

(54) METHOD AND APPARATUS FOR IMPROVING THE QUALITY OF DOCUMENT IMAGES WHEN COPYING DOCUMENTS

(76) Inventor: ANDREY ISAEV, Moscow Region (RU)

Correspondence Address: HAHN AND MOODLEY, LLP, 548 Market Street, San Francisco, CA, 94104, US

(21) Appl. No.: 12/708,419

(22) Filed: Feb. 18, 2010

Related U.S. Application Data
(60) Provisional application No. 61/153,552, filed on Feb. 18, 2009.

(51) Int. Cl. G06K 15/02; H04N 1/387; G06K 9/62; G06K 9/18; H04N 1/40

(52) U.S. Cl. 358/1.11; 358/453; 382/224; 382/182; 358/462; 382/224

(57) ABSTRACT

Embodiments of the present invention disclose a method to process an input image into a final image which is enhanced or improved. In accordance with the method, the input image is split into a plurality of layers. Each layer comprises objects of a single type. Each layer is for objects of a different type. Each layer is then processed separately to improve or enhance the quality of the objects therein. The final image is produced by integrating or synthesizing the plurality of layers. Apparatus to implement the method is also disclosed.

This application claims the benefit of priority to U.S. 61/153,552 which was filed Feb. 18, 2009, the entire specification of which is hereby incorporated by reference.

### FIELD

Embodiments of the present invention relate to the process of improving the quality of document images when copying documents.

### BACKGROUND

Simple image improvement methods may be used when copying documents using a copier or a Multi-Function Printer (MFP). These image improvement methods may include brightness optimization. Brightness optimization involves the use of cut-offs at regular levels: areas that are darker than a certain level become even darker, and areas that are brighter become brighter. This reduces noise but at the same time valuable information is irrevocably lost. After multiple copying, pages may be barely readable. This is the case because the typical image improvement algorithms cannot distinguish between information that is valuable to the user and information that can be safely removed.

### SUMMARY

Embodiments of the present invention disclose a technology that applies optical character recognition (OCR) methods to improve the quality of document images when copying documents. The disclosed technology detects valuable information and applies special methods to recreate it.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a general flow chart of the method of improving the quality of document images when copying documents.

FIG. 2 shows exemplary hardware for a system that implements the aforesaid method.

### DESCRIPTION

In the following description, for purposes of explanation, numerous specific details are set forth in order to provide a thorough understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Broadly, embodiments of the invention disclose the use of methods available in OCR systems and document image analysis tools to improve the quality of document images. Document pages may contain objects of different types, including those which are hard or impossible to detect, as well as meaningful objects like stamps, notes made by hand, signatures, barcode stickers, etc. In accordance with embodiments of the invention, a document image is not subjected to OCR proper, but it is analyzed by an OCR segmentation technology for the purpose of detecting and classifying all possible objects on the image.

In one embodiment, source documents may be hard copy and the result of image improvement and copying may also be hard copy.

In another embodiment, source documents are document images and the results of image improvement and copying are also images. These output images may be either the result of reverse synthesis or they may be in a multi-layered format similar to PDF.

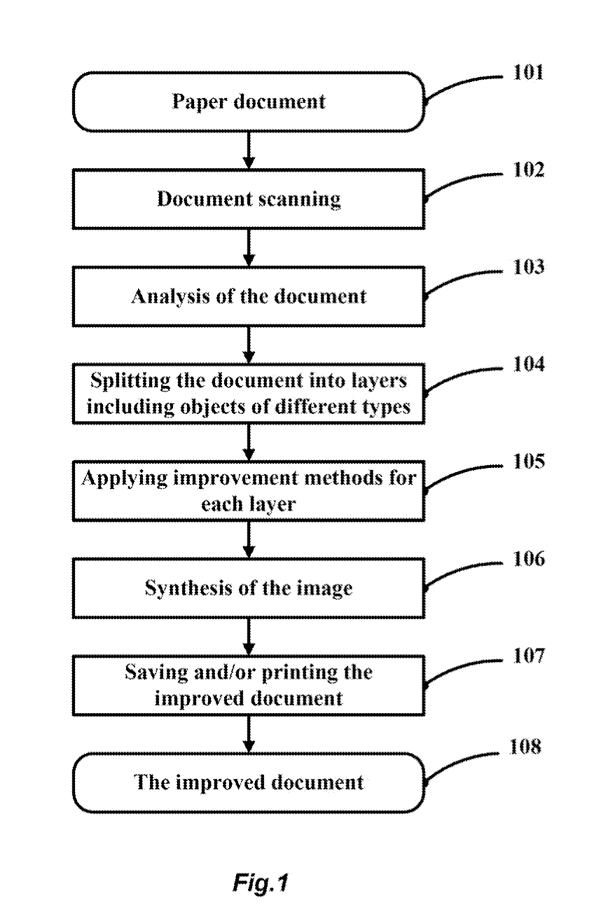

FIG. 1 is a general flow chart of the method of improving the quality of document images when copying documents. First, in the case of a paper document (101), the document must be scanned (102). Scanning produces an image of the document, i.e. its graphic representation in a digital image format. The method of the present invention may also be used without prior scanning to improve the quality of already existing electronic document images in PDF or TIP formats or document photographs.

Then the document image is analyzed (103) by an OCR segmentation technology (Document Analysis). The analysis procedure (103) can detect different types of objects on the image: text blocks, pictures, barcodes, notes made by hand, stamps, signatures, separators (table frames, lines, and rectangles), etc.

Based on the results of the analysis 103, the analyzed document image is split (104) into several layers: text, pictures, barcodes, notes made by hand, stamps, signatures, separators (table frames, lines, rectangles), etc. Each layer may be saved in a separate file of its own using a special technique.

Next, at step 105, each layer is processed separately and improved to the maximum extent possible using at least one improvement technique. According to various embodiments, the following improvement techniques may be performed:

(a) OCR is performed on the text and a combination of different improvement techniques may be applied.

(b) If the font used in the document can be detected, the characters may be reconstructed using the original font.

(c) If the original font cannot be detected, the system uses information from the OCR about identical characters in the text to reduce noise and improve the edges of the characters by matching identical characters on the page.

(d) Special image filters can be applied to the text layer to improve the shapes of characters without destroying other objects on the page.

(e) The pictures are processed by applying separate filters to improve their quality. Additionally, the pictures may be replaced with vector images if this is possible, which also reduces the size of the output file.

(e) In the notes made by hand and in the signatures, continuous lines are recreated, the noise is filtered out and lines are made thicker to make the text more legible. If required, stamps can be deskewed and OCR can be performed on them. The stamps are separated from the body text to prevent their interference with the OCR and specialized text reconstruction techniques described above. Then the stamps are improved separately from the rest of the text (their brightness range is corrected) and placed back on the reconstructed body text. The separators are subjected to OCR and their parameters (i.e. their size and thickness) are detected. The separators may be removed and then recreated in their entirety by relying on their coordinates on the page.

Once all the objects on the page have been detected, they are separated from the background. The background is analyzed separately, and its mean color is computed, together with variation from the mean. If the variation is smaller than a certain threshold value, the entire background is replaced with the mean color. If the mean color is only slightly different from white, the color background may be replaced by pure white. This procedure removes stains, defects introduced by uneven lighting or faded paper, noise introduced during scanning, paper creases, etc.

Next, during the synthesis 106 of the image, all the improved layers are merged to produce an image which is as close to the source image in terms of quality as possible and which can be saved and/or printed out. Different methods may be used to merge the layers. The layers may be actually merged to produce a resulting raster image, or they can be merged virtually to produce a raster image on demand (as in PDF). Then, the improved document 108 can be saved and/or printed 107 with high quality.

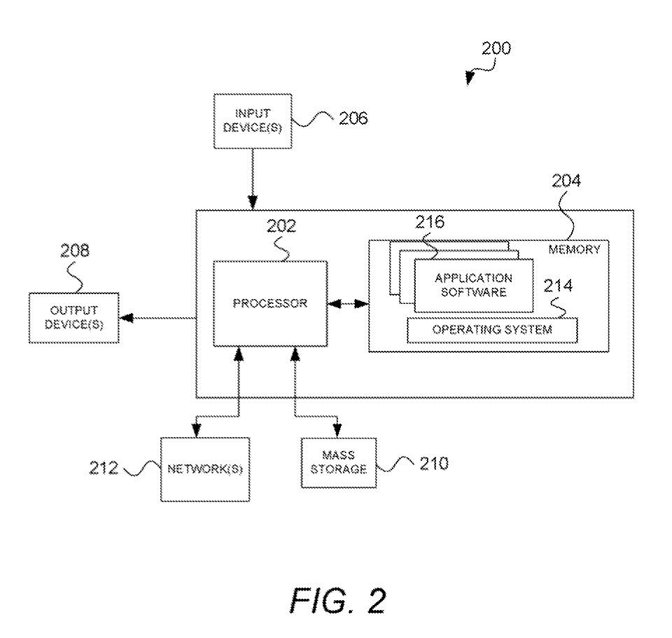

FIG. 2 shows an example of hardware 200 that may be used to implement the techniques disclosed herein The hardware 200 typically includes at least one processor 202 coupled to a memory 204. The processor 202 may represent one or more processors (e.g., microprocessors), and the memory 204 may represent random access memory (RAM) devices comprising a main storage of the hardware 200, as well as any supplemental levels of memory e.g., cache memories, non-volatile or back-up memories (e.g. programmable or flash memories), read-only memories, etc. In addition, the memory 204 may be considered to include memory storage physically located elsewhere in the hardware 200, e.g. any cache memory in the processor 202, as well as any storage capacity used as a virtual memory, e.g., as stored on a mass storage device 210.

The hardware 200 also typically receives a number of inputs and outputs for communicating information externally. For interface with a user or operator, the hardware 200 may include one or more user input devices 206 (e.g., a keyboard, a mouse, a scanner etc.) and a display 208 (e.g., a Liquid Crystal Display (LCD) panel). For additional storage, the hardware 200 may also include one or more mass storage devices 210, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 200 may include an interface with one or more networks 212 (e.g., a local area network (LAN), a wide area network (WAN), a wireless network, and/or the Internet among others) to permit the communication of information with other computers coupled to the networks. It should be appreciated that the hardware 200 typically includes suitable analog and/or digital interfaces between the processor 202 and each of the components 204, 206, 208 and 212 as is well known in the art.

The hardware 200 operates under the control of an operating system 214, and executes various computer software applications, components, programs, objects, modules, etc. indicated collectively by reference numeral 216 to perform the techniques described above

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

1. A method for processing an input image into a final image, the method comprising:
performing an image splitting operation to split the input image into a plurality of layers, each comprising objects of a particular type, wherein each layer is associated with a different object type;
separately performing at least one improvement technique on each layer to improve an image quality of each object therein; and
synthesizing the plurality of layers into a single layer to generate the final image.

2. The method of claim 1, further comprising, prior to performing the document splitting operation, first detecting and classifying all possible objects in the image.

3. The method of claim 2, wherein the detecting and classifying is based on optical character recognition (OCR) segmentation technology.

4. The method of claim 1, wherein each object type is selected from the group consisting of a text block, a picture, a barcode, a note made by hand, a stamp, a signature, and a separator.

5. The method of claim 4, wherein the separator is selected from the group consisting of a table, a frame, a line, and a rectangle.

6. The method of claim 1, further comprising saving each layer in a separate file.

7. The method of claim 4, the at least one improvement technique comprises optical character recognition (OCR) performed on text objects.

8. The method of claim 4, the at least one improvement technique comprises representing text in its original font, if said original font is detected.

9. The method of claim 4, the at least one improvement technique comprises, if said original font is not detected, using OCR information about identical characters to reduce noise and improve edges of the characters by matching identical characters.

10. The method of claim 4, the at least one improvement technique comprises at least one filter applied to improve shapes of characters.

11. The method of claim 4, wherein the at least one improvement technique comprises recreating continuous lines in hand-written notes and signatures.

12. The method of claim 4, wherein the at least one improvement technique comprises at least one filter applied to improve pictures.

13. The method of claim 4, wherein the at least one improvement technique comprises replacing each picture image with a corresponding vector image.

14. The method of claim 4, wherein the at least one improvement technique comprises deskewing each stamp and separating said stamp from body text.

15. A system, comprising:
a processor; and
a memory coupled to the processor, the memory storing instructions which when executed by the processor causes the system to perform a method for processing an input image into a final image, the method comprising:
performing an image splitting operation to split the input image into a plurality of layers, each comprising objects of a particular type, wherein each layer is associated with a different object type;
separately performing at least one improvement technique on each layer to improve an image quality of each object therein; and
synthesizing the plurality of layers into a single layer to generate the final image.

16. The system of claim 15, further comprising, prior to performing the document splitting operation, first detecting and classifying all possible objects in the image.

17. A computer-readable medium having stored thereon a sequence of instructions which when executed by a processing system causes the processing system to perform a method for processing an input image into a final image, the method comprising:
performing an image splitting operation to split the input image into a plurality of layers, each comprising objects of a particular type, wherein each layer is associated with a different object type;
separately performing at least one improvement technique on each layer to improve an image quality of each object therein; and
synthesizing the plurality of layers into a single layer to generate the final image.

18. The computer-readable medium of claim 17, further comprising, prior to performing the document splitting operation, first detecting and classifying all possible objects in the image.

19. The computer-readable medium of claim 16, wherein the detecting and classifying is based on optical character recognition (OCR) segmentation technology.

20. The computer-readable medium of claim 16, wherein each object type is selected from the group consisting of a text block, a picture, a barcode, a note made by hand, a stamp, a signature, and a separator.
